(19) United States
(12) Patent Application Publication
(10) Pub. No.: US 2022/0113945 A1
(43) Pub. Date: Apr. 14, 2022

(54) ENTROPY PROVIDER

(71) Applicant: Quside Technologies S.L., Barcelona (ES)

(72) Inventor: Carlos ABELLAN, Barcelona (ES)

(21) Appl. No.: 17/561,173

(22) Filed: Dec. 23, 2021

Related U.S. Application Data
(63) Continuation of application No. PCT/EP2020/068887, filed on Jul. 3, 2020.

(30) Foreign Application Priority Data
Jul. 5, 2019 (EP) 19382578.3

(51) Int. Cl. G06F 7/58

(52) U.S. Cl. CPC G06F 7/58

(57) ABSTRACT

An entropy provider for providing entropy to a computing device external to the entropy provider, the entropy provider comprising a power source and an entropy supply, wherein the power source is adapted to provide power to the entropy supply and wherein the entropy provider comprises a transmitter for transferring the entropy from the entropy supply to an external computing device.

### CROSS-REFERENCE TO RELATED APPLICATIONS

This application is a continuation of International Application No. PCT/EP2020/068887, filed on Jul. 3, 2020, which claims priority under 35 U.S.C. § 119 to European Application No. EP 19382578.3 filed on Jul. 5, 2019, the entire contents of which are hereby incorporated by reference.

### FIELD

The present disclosure is related to entropy generation. For example, the present disclosure is directed to generating random numbers or specifically designed sequences of bits for use by computing device.

### BACKGROUND

Computing devices have become a very important part of everyday life. This does not only refer to the computing devices used by their owners privately, for example at home (in the form of personal computers) or while they are on the move (mobile devices like laptops, smartphones and the like), but this also refers to the computing devices used at work. Further, this refers to inexpensive sensors and actuators used, for example, as part of devices connected to the internet (Internet of Things, IoT). These computing devices may exchange private and/or sensitive information, including information exchanged in in smart home environments. Further application of such devices can be found in industry plants, specifically in the field known as “Industry 4.0”.

In view of the sensitive data usually processed at work, as well as the sensitive data used in the private field (e.g., banking accounts or communications in general), the use of entropy in the form of, for example, random numbers or specifically designed sequences of bits has become more important. In some IoT scenarios, the security of communications and data transfer in general might even have direct influence on the physical security of people and/or property, for example in the field of power and water supply.

The generation and use of entropy usually requires specifically adapted programs and/or specifically adapted hardware. Examples of such specifically adapted programs or hardware include entropy generators that generate entropy using physical processes that, by their nature, are random. However, generating unpredictable random numbers at fast rates is challenging. The generation of entropy with such generators can require significant amounts of space or processing complexity. These space and complexity requirements may result in less preferable experiences by the user of the computing device on which the random number generation is running. In some instances, the space and complexity requirements may make random number generation cost prohibitive for some IoT-devices that require extreme integration or low complexity. These requirements make the generation of high-quality random values even more challenging, thus affecting the security of communications between devices and data transfer in general.

While there are systems known that can directly communicate with external servers (for example in the field of managing banking accounts) that create tokens or random numbers permanently, devices that provide entropy to a specific computing device used by a user are known to be provided internally to those computing devices or provided in a manner that makes use of the hardware of the computing devices (for example in the form of USB sticks on which specific programs are stored that are run by the computing system to which the USB stick is connected). They make thus use of the processing capabilities or power of the device to which they are mounted.

While those mobile devices, like USB sticks, can be carried along with the user, and for example, used with a plurality of computing devices, they still suffer from the disadvantages mentioned above.

Therefore, absent from the art are techniques that provide or generate entropy used by a computing device while, at the same time, preventing disadvantageous experiences by the user and not requiring, or at least reducing, the requirement of additional hardware.

### SUMMARY

The techniques of the present disclosure are directed to an entropy provider for providing entropy to a computing device external to the entropy provider. The entropy provider includes a power source and an entropy supply, wherein the power source is adapted to provide power to the entropy supply and wherein the entropy provider comprises a transmitter for transferring the entropy from the entropy supply to an external computing device.

The computing device external to the entropy provider may be any device with computing capabilities. This does not refer to isolated devices for storing data. The computing devices should thus at least possess the capability of processing, i.e. using the entropy (e.g., for encrypting communications). The computing devices may, however, not be limited to devices like smartphones or personal computers. Also industry plants and devices from the field of “Internet of Things.” IoT, like refrigerators, sensors and the like, to name a few examples, are considered as computing devices that can be external to the entropy provider and can be provided with entropy if needed. Furthermore, devices like wireless headsets or microphones may be considered as computing devices external to the entropy provider. Transferring entropy to these devices can be advantageous to secure communications sent over a wireless channel, for example.

The entropy provider according to the techniques of the present disclosure is thus preferably designed to generate entropy (e.g., in the form of random numbers or a random sequence of bits) in a manner that is independent from the processing capabilities of the external computing device and transfers the random numbers after their generation to the specific computing device, but only requiring that the external computing device is provided with sufficient storage for storing the entropy.

An entropy provider for generating real entropy values using a physically random process is, in one embodiment, understood to be or comprise a chip or other combination of software and/or hardware that generates random values or entropy values making use of a physical process that takes place preferably on this entropy-chip and truly yields random values. This can, for example, comprise arbitrary interference values of sources of laser light where the sources or at least one of the sources is powered to a value almost reaching and only occasionally exceeding the lasering threshold. Thereby, a random phase relation between the two signals is generated allowing for generating real random values of entropy. A corresponding system in the form of the optical component is described in EP 19382318.4 owned by the applicant, the content of which is herewith incorporated by reference.

Sources of entropy or entropy generators are also known from WO 2019/086730 A1, the content of which is herewith incorporated by reference.

In this document, a process for the physical generation of random numbers is described where the process includes the steps of: modulating the gain of a vertical cavity surface emitting laser periodically from the lower threshold to the upper threshold and back; keeping the round-trip gain positive for a longer period than the cavity round-trip time; keeping the net gain per round trip negative for a longer period than the cavity round trip time, to create random amplitude pulses; detecting optical pulses; converting optical pulses to electrical analog pulses; digitizing electrical analog pulses into random numbers. The physical components used to realize this procedure can be used in the context of the techniques of the present disclosure as a source of entropy or an entropy generator.

A further random number generator or entropy generator is described in U.S. Pat. No. 9,218,160 B2, the content of which is herewith incorporated by reference.

Described therein is a process for generating random numbers via a quantum random number generator, the process comprising the steps of: a) operating a laser in single mode and high modulation bandwidth via an electrical pulse driver to produce phase randomized optical pulses, b) transforming the phase randomized optical pulses produced in a) into optical pulses with random amplitude, and c) detecting the resulting random amplitude signals via a fast photodiode, so as to thereby generate random numbers based solely on the random amplitude signals. The thus generated random numbers can be used in the context of the techniques of the present disclosure.

As the entropy provider described in the present disclosure does not require a power source external to the entropy provider, it can be used to provide entropy at any location, thereby making it easier for the user to make use of the thus generated entropy in any environment and to make it available to distributed devices in, for instance, production plants.

The transmitter according to the techniques of the present disclosure is a transmitter that is, preferably, specifically adapted for only transferring data in the form of entropy or, potentially, additional data used for further processing the entropy. The transmitter, however, may not be intended or designed for also transferring energy from the entropy generator to the external computing device. The energy generated by the power source can thus be completely used by the entropy provider to generate and/or manage and/or transfer the entropy. The entropy supply according to the techniques of the present disclosure is not necessarily able to, on its own, generate entropy but may only be able to store the entropy and can, thus, be also embodied in the form of a storage device like a flash storage or other solid-state storage.

In one embodiment, the entropy supply comprises an entropy generator for generating the entropy.

With such an entropy generator, it is possible to generate the entropy with the entropy provider “on the fly.” For example, entropy may be generated “on the fly” in case the entropy provider is connected to an external computing device. Additionally, as long as the entropy provider is not connected to an external computing device, the power supply of the entropy provider may still allow for generating entropy, thus allowing the entropy provider to generate a “pool” of entropy that can, for example, be stored in a storage device internal to the entropy provider for later use.

In a further embodiment, the entropy provider comprises a controller for controlling the generation of entropy by the entropy generator and/or the provision of power from the power source to the entropy generator.

With this controller, the management of the entropy generated and the power used by the entropy provider is possible. As the entropy provider according to the techniques of the present disclosure is a self-standing device that is not necessarily connected to an external power source, the power available to the entropy provider is necessarily limited. By managing the use of this power with the controller, the lifetime and usability of the entropy provider can be increased.

Furthermore, the controller may comprise at least one button that, upon actuation, can cause the power supply to provide power to the entropy generator, causes the entropy generator to generate entropy, and/or causes the entropy provider to provide entropy generated by the entropy generator to an external computing device.

By providing the controller with such a button, the functionalities of the entropy provider can be controlled by a user according to his or her needs, thereby making the user-defined management of the entropy easier.

In an alternative embodiment, the entropy supply comprises a storage for storing entropy. In such an embodiment, the entropy provider comprises a receiver for receiving entropy from an external entropy source, and the entropy provider is adapted to store entropy received from the external entropy source in the storage.

While there may be a storage device associated with the entropy generator according to the above embodiments, this embodiment is intended to refer to an entropy provider that does not comprise an entropy generator internal to the entropy provider, or at least refers to a storage device in the entropy provider that is not connected to such an entropy generator. This storage device can only receive the entropy generated somewhere else and can store the respective entropy in the storage.

The storage according to this embodiment may either be provided as a volatile or nonvolatile storage. If it is provided in the form of a volatile storage, it may be provided that the volatile storage is permanently powered by the power source in order to maintain the entropy stored in the storage.

With this embodiment, the entropy provider can be realized as an inexpensive device that only needs to provide storage capability and a processor that allow for receiving and transferring the entropy to an external computing device. As the storage and transfer of data do not require significant amounts of energy, the power source can be dimensionally small, thus reducing the overall size of the entropy provider, and overall simplifying the architecture of the external computing device (like a sensor, actuator or computing device) significantly.

In one embodiment, the entropy provider comprises a controller for controlling the receiving of entropy from an external entropy source and/or the provision of entropy from the storage to an external computing device via a transmitter. Such a controller may optionally include an actuator that, upon actuation, cause the entropy provider to start receiving entropy from the external entropy source and/or start providing entropy from the storage to the external computing device.

With this controller, the management of the receiving, storing and providing of entropy can be provided in an efficient manner, thereby resulting in the efficient management of the energy available via the power source. If an actuator, for example in the form of touchscreens or buttons on mobile applications running on smartphones or the like, are provided, manual control of this management is provided for the user.

In one further embodiment, the entropy comprises random numbers and/or a random sequence of bits.

Depending on the field of application of the respective entropy, the use of either random numbers or the use of a random sequence of bits may be advantageous. The random numbers can have a specific length (for example 100 digits). The random sequence of bits may also be a sequence of a specific length where only the provision of 0's and 1's in this sequence is in fact random. For example, the entropy may be provided as 128 or 256 full entropy bits. On the other hand, it may also be provided that the random numbers and/or the random sequence of bits have a random/arbitrary length up to a maximum length and/or comprising at least a minimum length (for example 10 digits different from zero or at least 20 bits).

In a further embodiment, the power source comprises at least one of: a battery, a rechargeable battery that can be recharged via a power supply external to the entropy provider, and/or a solar cell. In such an embodiment, the transmitter may include at least one of: a wireless transmitter for wirelessly transmitting entropy to an external computing device, and/or a port for connecting a cable for data transfer for transferring entropy to an external computing device.

The respective power sources allow for a wide area of application of the entropy provider. For example, the use of solar cells makes the entropy provider completely independent from any external power source, while the use of batteries or rechargeable batteries provides a more stable power supply. The use of a wireless transmitter makes the transfer of the entropy easy for the user and does not require the availability of physical ports. The use of a physical port for a cabled connection of the entropy provider and the external computing device reduces the risk of malicious attackers getting access to the entropy provided from the entropy provider to the external computing device. Near-field wireless transmission can provide both the convenience of wireless connectivity and risk reduction in view of potentially malicious attackers.

Also provided for is a method for transferring entropy from an entropy provider to a computing device external to the entropy provider. The entropy provider comprising a power source and an entropy supply. According to the techniques of the present disclosure, the method includes the operations of providing power to the entropy supply via the power source, and providing entropy from the entropy provider to the external computing device via a transmitter when the entropy provider and the external computing device are connected via the transmitter.

This method allows for easy and efficient provision of entropy to an external computing device while, at the same time, not negatively influencing the experience of the user while using the external computing device.

In one embodiment, the entropy supply comprises an entropy generator for generating the entropy. According to such an embodiment, the entropy generator generates entropy when it is powered by the power source.

With this embodiment of the method, the entropy can be generated with the entropy provider itself, thus ensuring that, in principle, any required amount of entropy can be generated as necessary. If, for example, an external computing device requires 100 MB of entropy, this entropy can be generated with the entropy generator either while a connection with the external computing device is established or prior to the establishment of such a connection, thus only requiring further transfer of the already generated entropy. If additional entropy is required, it can be generated as needed or on demand.

Further, the entropy provider can comprise a controller that controls the generation of entropy by the entropy generator and/or the provision of power from the power source to the entropy generator.

With this embodiment, the management of the entropy and the available power is realized in an efficient manner.

It may also be provided that the controller comprises at least one button that, upon actuation, causes the power supply to start providing power to the entropy generator, causes the entropy generator to generate entropy, and/or causes the entropy provider to provide entropy generated by the entropy generator to an external computing device.

With this embodiment, user-dependent management of the available entropy and/or power is realized.

In an alternative embodiment, the entropy supply comprises a storage that stores entropy. According to such an embodiment, the entropy provider comprises a receiver that receives entropy from an external entropy source when the entropy provider is connected to the external entropy source via the receiver. The entropy provider stores entropy received from the external entropy source in the storage. According to more specific example embodiments, the storage stores the entropy without requiring energy from the power source.

According to such embodiments, the entropy provider acts as portable entropy storage allowing for transferring entropy from the actual entropy generator (e.g., a specifically dedicated computing device) to the computing device that will actually make use of the entropy generated. Such an embodiment makes it quite easy for the user to transfer his required entropy.

In a further embodiment, the entropy provider comprises a controller that controls the receiving of entropy from the external entropy source and/or the provision of entropy from the storage to the external computing device via the transmitter. According to more specific example embodiments, the controller includes an actuator that, upon actuation, causes the entropy provider to start receiving entropy from the external entropy source, start providing entropy from the storage to the external computing device, and/or provide the same entropy to more than one external computing device.

With this, the management of the provision of entropy and the power management of the power source can be facilitated in an efficient manner and may also provide for manual management of the same.

In one embodiment, the entropy comprises random numbers and/or a random sequence of bits.

The use of random numbers or a random sequence of bits may be advantageous depending on the field of application. Specifically, the random sequence of bits may be used when encrypting communication and/or in authentication. The random numbers may be used, for example, in the field of gaming, randomized algorithms or identification for accessing specific accounts.

In the embodiments described above so far, the entropy supply was described to either comprise an entropy generator or to comprise a storage that can be provided with entropy via an external entropy source. However, combinations are also possible. For example, a storage may be included in the entropy provider in which entropy from an external entropy source is stored. In addition, an entropy generator as described above can be provided in the entropy provider to further generate entropy. The entropy generated by this entropy generator can be stored in either the storage or there can be provided an additional storage to which the entropy generated by the entropy generator is stored. This can be useful in case the entropy generator generates entropy with a different security compared to the entropy generated by the external entropy source. If, for example, the entropy generator provided on the entropy provider is embodied in the form of an algorithmic entropy generator, its pseudo-random values may be useful for further applications on an external computing device only requiring a minor level of security. The external entropy source may then be embodied in a manner that provides entropy with a higher degree of security (for example true random numbers making use of one or more physical processes). Those random numbers are then transferred to the corresponding storage and are then used to be transferred on to an external computing device in case increased security is needed, such as providing entropy for encrypted communications. This provides the advantage that the energy required at the entropy provider can be reduced as the generation of real entropy making use of physical processes is usually larger compared to the generation of pseudo entropy using algorithmic entropy generators.

### BRIEF DESCRIPTION OF THE DRAWINGS

FIG. 1 shows a schematic depiction of an entropy provider, according to an example embodiment.

FIG. 2 shows an entropy provider including a controller with at least one button, according to an example embodiment

FIG. 3 shows an entropy provider comprising a storage for storing the entropy, according to an example embodiment.

### DETAILED DESCRIPTION

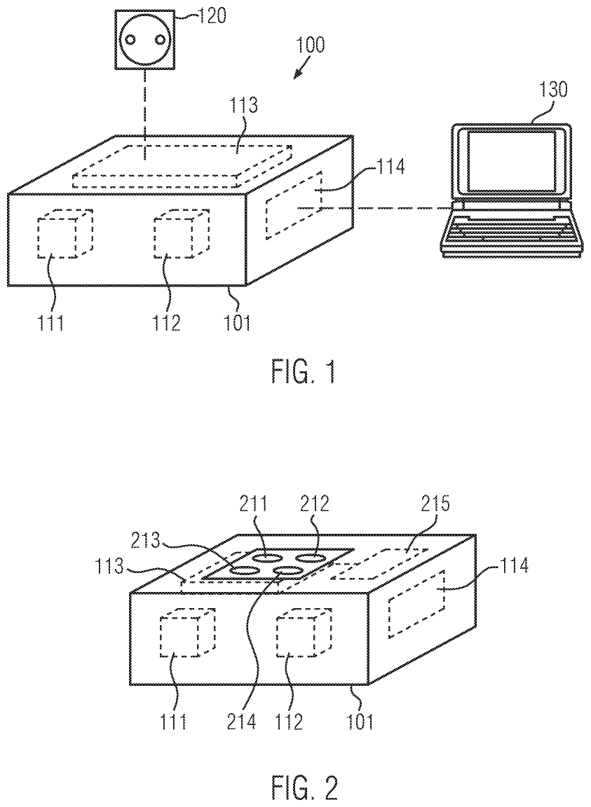

FIG. 1 shows an entropy provider 100 according to an example embodiment of the techniques of the present disclosure. The entropy provider 100 is depicted in FIG. 1 in connection with an external computing device 130. The entropy provider 100 is, according to the techniques of the present disclosure, adapted to transfer entropy to the external computing device 130 to which it is connected.

For this, the entropy provider 100 comprises at least an entropy supply 111 and a transmitter 114 for transferring the entropy from the entropy supply 111 to the external computing device 130.

Transmitter 114 may be embodied in the form of either a wireless transmitter or a wired transmitter. This means in the case of a wireless transmitter that the transmitter 114 comprise at least a wireless transmitter that can generate, for example, electromagnetic signals or acoustic signals or other signals that do not require a cable for transferring data. By modulating these signals, data in the form of the entropy from the entropy supply 111 can be provided from the entropy provider 100 via the transmitter 114 to the external computing device 130. For example, the transmitter 114 may be provided in the form of a commonly known wireless transmitter or a wireless transceiver.

In the case of the transmitter 114 being embodied in the form of a cabled transmitter, the transmitter 114 may be provided in the form of a port to which a cable can be connected where the port is adapted to transfer data from the entropy provider 100 via a corresponding cable to the external computing device 130. For example, the transmitter 114 may be realized in this case in the form of a USB port, Mini-USB port or Micro-USB port or a lightning port. When connecting this port with a corresponding cable to an external computing device 130, the entropy can be provided via this transmitter 114, i.e. via the port, through the cable to the external computing device.

In preferred embodiments, it is intended that the data transferred via the transmitter 114 is stored at the external computing device 130 in a dedicated storage (e.g. for later use). However, the actual use of the entropy by the external computing device 130 is not intended to limit the techniques of the present disclosure and is, therefore, arbitrary with respect to how this entropy is actually used, for example, in order to encrypt communication, provide random numbers for logging into or maintaining a connection for a banking account or any other application.

The entropy provided by the entropy supply 111 may have the form of either random numbers and/or random sequences of bits. In the case of random numbers, this means that the entropy is provided in the form humanly readable sequences of digits, for example 123 and 456. In the case of the entropy being provided in the form of a random sequence of bits, the entropy is provided by the entropy supply in the form of a sequence of bits where the 0's and 1's are randomly distributed over the respective sequence.

The random numbers and/or the random sequence of bits may be provided in the form of numbers or sequences with a specific length (for example 20 digits in the case of random numbers or 40 bits in the case of a sequence of bits). However, it is also possible that the random numbers generated have almost arbitrary length and/or the random sequence of bits has arbitrary length. In the case of arbitrary length of the random numbers and/or sequence of bits, the length may be set to range from a minimum value (for example 20 digits or bits) to a maximum length (for example 500 digits or 2000 bits). The actual minimum length and/or maximum length, however, is not limited and may have any value as considered appropriate in view of, for example, security requirements regarding the encryption of communication with the respective entropy. It might even be the case that the complete storage of the computing device is filled in with random numbers or random bits, such as 1 GB, 5 GB, 10 GB or 100 GB. This can also depend on the available storage of the device.

The entropy supply 111 can be provided in a plurality of forms. Basically, the entropy supply 111 may either comprise an entropy generator (and potentially associated components) or it may be provided in the form of a storage for storing entropy only.

In the first case, the entropy generator can be embodied in the form of a physical or algorithmic entropy generator. The first one refers to an entropy generator that uses a physical process (for example governed by the laws of thermodynamics or making use of quantum physical processes) in order to generate (true) random numbers due to the (true) randomness of the respective physical process. For example, the phase of a first “reference” laser source and the phase of a laser source that is driven close to the lasering threshold and close above the lasering threshold is completely arbitrary due to the laws of quantum mechanics. Making use of such a system embodied in the entropy supply results in arbitrary interference signals of the respective laser signals which can then be used to generate unpredictable random values (for example digits or bits).

Algorithmic entropy generators may be embodied in the entropy supply by, for example, providing a processor or other entity that uses a specific program code to generate random numbers. Those random numbers usually are only “pseudo” random numbers as they use a precisely defined, and therefore, deterministic algorithm that uses as initialization value for example the date or the actual time in order to create numbers or sequences or bits. As the underlying program code is deterministic, the resulting numbers or bits are not truly random but are “pseudo random”.

In case the entropy supply 111 is merely provided in the form of a storage for storing the entropy, this storage can be provided as a volatile or nonvolatile storage to which entropy can be provided by an external entropy source.

This external entropy source may be a specifically dedicated computing system that generates entropy (in the form of random numbers or sequences or bits). In case the entropy provider 100 is connected to this computing device for example via a wired or wireless connection (making, for example, use of the transmitter 114) entropy can be “downloaded” from this external entropy source and transferred to the storage where it is stored for later use.

Furthermore, the entropy provider 100 comprises a power source 113 for providing power to the entropy supply. In the case of the entropy supply being provided in the form of an entropy generator, this power may be used to generate the entropy. Furthermore, in the case of the entropy supply being provided in the form of a storage, the power source may be used to power the storage in case it is embodied in the form of a volatile storage in order to maintain the information (i.e. entropy) in this volatile storage. Additionally, the power provided by the power source 113 may be used to transfer the entropy from the entropy supply 111 via the transmitter 114 to the external computing device 130. Specifically, if the transmitter 114 is embodied in the form of a wireless transmitter, the power provided by the power source 113 may be used to power the wireless transmitter. Correspondingly, if the transmitter 114 is provided in the form of a USB port or any other physical port, the power provided by the power source 113 may be used to generate corresponding electrical signals for transferring the entropy from the entropy supply 111 to the external computing device 130 via the port.

The power source 113 may be embodied in a variety of forms. In one embodiment, the power source 113 is provided as at least one battery. Alternatively, the power source 113 may be provided in the form of rechargeable batteries or other rechargeable energy units. In this case, the power source 113 can be connected to an external power supply like an electric socket 120 as exemplarily depicted in FIG. 1. Once the rechargeable batteries are charged (either full or to a different demand), the entropy provider can be disconnected from the external power supply and can be taken along with the user for connecting to an external computing device and transferring entropy to the same.

In another alternative, the power source 113 may be provided in the form of one or more solar cells that can absorb solar energy and provide electrical energy generated therewith for powering the components of the entropy provider 100 and specifically the entropy supply 111.

In any case, it is intended that the entropy provider 100 is at least for a specific period of time “self-standing” in the manner that it has its own integrated power source 113 that can provide power to at least the entropy supply 111 for an amount of time. This allows the entropy provider 100 to be carried along with a user and provide entropy to another external computing device 130 without the need for an additional power source.

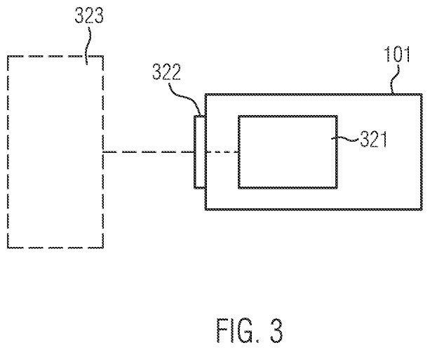

Furthermore, the entropy provider 100 may comprise additional components 112. Such components may be internal circuitry or connections or other elements that, for example, control the power source 113, the entropy supply 111, and/or the transmitter 114. They can be embodied in the form of one or more processors or storage devices or other elements that are, for example, necessary to store or further process the entropy generated by the entropy generator in case the entropy supply 111 is embodied in the form of an entropy generator. Furthermore, such components may be used in order to manage the storage of entropy in the entropy supply 111 if it is embodied in the form of a storage device as discussed above and as will be discussed further with reference to FIG. 3. Those additional components can also further process the entropy generated in order to decide whether or not it is to be transferred to an external computing device 130 (upon request).

For example, assuming that the entropy comprises a plurality of random numbers. If the length of the random numbers during their generation is left open, the random numbers may comprise random numbers that have a length below a given threshold (for example 100 digits) and random numbers that have a length exceeding this threshold. In case the further processes on the external computing device that make use of the entropy require random numbers of a minimum length of 100 digits, the additional components 112 can control the transfer of the entropy such that only random numbers with at least 100 digits are transferred to the external computing device 130 while the others are either maintained in the entropy provider or are deleted. Of course, the threshold may be set to any predetermined value and the above is only an example.

Additionally, in order to increase the security of the further processes carried out on the external computing device 130 making use of the entropy of the entropy provider 100, the components can make sure that the entropy that is transferred to the external computing device 130 is completely erased from the entropy provider 100. This makes sure that entropy is not used several times which could weaken the security of the processes at the external computing devices 130 making use of the entropy. Also, the entropy might be delivered with additional information and/or processing to securely transfer the entropy to the computing device 130.

The entropy provider 100 may further comprise a housing 101 in which the dedicated components, i.e. the entropy supply 111, the transmitter 114 and the power source 113, as well as (if provided) the additional components 112, are provided. The housing 101 can comprise physically secure hardware so as to prevent opening of the entropy provider 100 that might be necessary in certain security environments.

FIG. 2 shows a further embodiment of the entropy provider as depicted in FIG. 1. In this embodiment, in addition to the components discussed so far, controller 215 is provided. The controller 215 can also form part of the additional components 112 described above. As the controller 215 described in this embodiment fulfils specific tasks, it is only depicted for ease of explanation as additional components.

The controller 215 may be provided to control specific functionalities of the entropy provider. Among those functionalities, the controller 215 may control the generation of entropy in case the entropy supply 111 is embodied in the form of an entropy generator and/or they may control the provision of power from the power source 113 to this entropy generator. In case the entropy supply 111 is embodied in the form of a storage, the controller 215 may be provided to control the receiving of entropy from an external entropy source (see FIG. 3) and/or they may control the provision of entropy from the storage to the external computing device by making use of the transmitter 114.

The controller 215 can comprise circuitry and/or processors for performing the above mentioned tasks. Controller 215 may also comprise additional storage for, for example, storing specific programs that allow the controller 215 to control the other components. Basically, the controller 215 may be embodied as an automatically acting controller. For example, controller 215 may cause the entropy generator to generate entropy if a connection to an external computing device is established as long as the external computing device requests entropy from the entropy provider. In the same manner, if the entropy supply 111 is provided in the form of a storage, the controller may control the components of the entropy provider to receive and store entropy from an external entropy source as long as a connection to the external entropy source is established and/or as long as the storage has further capability of storing additional entropy.

Further sophisticated programs may be provided with the controller 215 that manage the provision or storage of entropy in a specific manner. Furthermore, the provision of entropy to different devices may be managed. This may include transferring either the same random numbers to a plurality of devices (2, 3 or more) or not transferring identical entropy to different devices.

In addition or alternatively to this automatic management of the respective functions of the entropy provider, the controller 215 may also comprise buttons 211 to 214 (or any other arbitrary number of buttons) that allow for physical interaction with a user. Instead of buttons, other physical elements or even virtual elements may be provided for interaction with a user. For example, a touchscreen may be provided that can be actuated by the user. Also, (mobile) applications running on a computing device, like a smartphone, may be used to provide interaction with a user. Generally, the elements 211 to 214 may be seen to refer to an “actuator” that allow for an interaction with a user. The elements 211 to 214 may be provided integrated with and/or remote to the entropy provider. Also a combination of actuation elements provided integrated with the entropy provider (like one or more buttons) and an actuator remote or external to the entropy provider (like a fingerprint scanner on a smartphone for authenticating the user of the entropy provider) can be realized. Also, applications running on additional hardware and including, for example a special user interface or a set of functions that can be activated by software, may be considered as an actuator in the sense of the techniques of the present disclosure.

In the description that follows, reference will be made to buttons for ease of explanation. However, these buttons may be considered only as specific examples of the actuators mentioned above. Any functionality provided by the buttons explained below may likewise be realized with any type of actuator known to the skilled artisan.

Upon actuation of one or more of these buttons 211 to 214, the controller 215 may perform their respective functionality. For example the button 211 may be used to cause the controller to start the provision of entropy from the entropy provider (specifically the entropy supply) to an external computing device. This means that the transfer of entropy from the entropy supply 111 to the external computing device is preferably not immediately started once a corresponding connection via the transmitter 114 is established. A further input from the user via the button 211 may be necessary to start this process where the controller 215 are then actuated to cause the entropy supply (and optionally also one or more of the additional components 112) to transfer the available entropy. A further activation of this button 211 may cause a stop of the transfer of entropy from the entropy supply 111 to the external computing device irrespective of whether the connection to the external computing device via the transmitter 114 is still existing.

Correspondingly, there may be provided a further button 212 that, upon actuation, causes the controller 215 to start or stop the transfer of entropy from an external entropy source to the entropy supply 111 (for example in case the entropy supply is embodied in the form of a storage for entropy). A further button 213 may be provided that, upon actuation, causes the power source 113 to provide power to an entropy generator of the entropy supply 111 irrespective of whether there is a connection to an external computing device that requires entropy. Thereby, the user has full control of when entropy is generated with the entropy provider. A further button 214 may be provided that, upon actuation, activates the transmitter 114. Without actuation of this button 214, no connection may be established to any external device (be it an external entropy source or be it an external computing device requiring entropy). Thereby, specifically in the case of the transmitter 114 being a wireless transmitter, a further security barrier is established making it more difficult for a malicious attacker to get access to the entropy stored on the entropy provider as long as he has no physical access to the entropy provider.

Other functions may also be realized using these buttons depending on the functionality provided for the entropy provider.

FIG. 3 shows a further embodiment of the entropy provider where the entropy provider comprises a storage 321 that is adapted to store entropy and to upload this entropy (via the transmitter) to an external computing device requiring the entropy.

The entropy provider according to this example embodiment does not comprise an integrated entropy generator and can, thus, not generate entropy on its own. However, it still comprises a power source as described with respect to FIGS. 1 and 2 and will also comprise a transmitter as described with respect to FIGS. 1 and 2 for transferring entropy to an external computing device requiring the respective entropy. All other embodiments described with respect to the above FIGS. 1 and 2 may also be applied in the embodiment of FIG. 3 (with the exception that no entropy generator is provided in the entropy provider according to FIG. 3).

In order to provide entropy to the storage 321, there may be a connector 322 provided with which a connection to an external entropy source 323 can be established. The connector 322 may be identical to the transmitter or they may be provided as another element. For example, while the transmitter mentioned above may be realized in the form of a wireless transmitter, the connector 322 may be provided as a physical port for connecting a cable that can be connected to the external entropy source. Thereby, the access to the external entropy source 323 can be restricted to devices that establish a wired connection to the external entropy source 323.

Once the entropy provider is charged with the respective entropy from the external entropy source 323, it can be disconnected from the external entropy source 323 and later on connected to an external computing device for transferring entropy. In order to increase the security of the external entropy source 323 further, it can be provided that a connection for data transfer between the entropy provider on the one side and the external entropy source 323 on the other side can only be established as long as the entropy provider is not, at the same time, connected to an external computing device. Thereby, indirect access of the external computing device to the external entropy source via the entropy provider can be prevented.

The storage 321 of this embodiment may be provided either as volatile storage or as nonvolatile storage.

In the case of the storage being provided in the form of a volatile storage, maintaining the entropy provided to this storage requires energy all the time. Therefore, in this specific embodiment, the power source of the entropy provider may be adapted to permanently transfer a sufficient amount of power to the volatile storage for maintaining the entropy store therein. The storage may be embodied as a nonvolatile storage for example in the form of a flash or any other solid-state storage device. In order to reduce the dimensions of the entropy provider, realizations making use of flash-storages or other storages may be preferred compared to other hard drives.

In order to make sure that the storage can store sufficient entropy for providing it to at least one external computing device, the storage capacity of the storage device can be at least 100 MB or up to a plurality of gigabytes.

In the embodiments described above so far, the entropy supply was described to either comprise an entropy generator or to comprise a storage that can be provided with entropy via an external entropy source. However, also combinations are possible. For example, there can be provided a storage in the entropy provider in which entropy from an external entropy source is stored. In addition, an entropy generator as described above can be provided in the entropy provider to further generate entropy. The entropy generated by this entropy generator can either also be stored in the storage or there can be provided an additional storage to which the entropy generated by the entropy generator is stored. This can be useful in case the entropy generator generates entropy with a different security compared to the entropy generated by the external entropy source. If, for example, the entropy generator provided on the entropy provider is embodied in the form of an algorithmic entropy generator, its pseudo-random values may be useful for further applications on an external computing device only requiring a minor level of security. The external entropy source may then be embodied in a manner that provides entropy with a higher degree of security (for example true random numbers making use of one or more physical processes). Those random numbers are then transferred to the corresponding storage and are then used to be transferred on to an external computing device in case increased security, for example, for encrypting communication is needed. This provides the advantage that the energy required at the entropy provider can be reduced as the generation of real entropy making use of physical processes is usually larger compared to the generation of pseudo entropy using algorithmic entropy generators.

What is claimed is:

1. An apparatus comprising:
an entropy supply;
a power source configured to provide power to the entropy supply; and
a transmitter configured to transfer entropy from the entropy supply to an external computing device.

2. The apparatus of claim 1, wherein the entropy supply comprises an entropy generator for generating the entropy.

3. The apparatus of claim 2, further comprising a controller configured to control generation of entropy by the entropy generator and/or control the provision of power from the power source to the entropy generator.

4. The apparatus of claim 3, wherein the controller comprises at least one actuator that upon actuation causes the power source to provide power to the entropy generator, causes the entropy generator to generate entropy, and/or causes the apparatus to provide entropy generated by the entropy generator to the external computing device.

5. The apparatus of claim 1, further comprising a receiver configured to receive entropy from an external entropy source, wherein the entropy supply comprises storage for storing entropy received from the external entropy source.

6. The apparatus of claim 5, further comprising a controller that controls receiving of entropy from the external entropy source via the receiver and/or controls the provision of entropy from the storage to the external computing device via the transmitter.

7. The apparatus of claim 6, wherein the controller comprises at least one actuator that upon actuation causes the receiver to start receiving entropy from the external entropy source and/or causes the transmitter to start providing entropy from the storage to the external computing device.

8. The apparatus of claim 1, wherein the power source comprises at least one of: a battery, a rechargeable battery that can be recharged via a power supply external to the apparatus, or a solar cell; and
wherein the transmitter comprises at least one of a wireless transmitter for wirelessly transmitting entropy to the external computing device or a port for connecting a cable for transferring entropy to the external computing device.

9. The apparatus of claim 1, wherein the entropy comprises random numbers and/or a random sequence of bits.

10. A method comprising:
providing power to an entropy supply of an entropy provider via a power source of the entropy provider; and
transferring, via a transmitter of the entropy provider, entropy from the entropy provider to a computing device external to the entropy provider when the entropy provider and the external computing device are connected via the transmitter.

11. The method of claim 10, wherein the entropy supply comprises an entropy generator for generating the entropy, and wherein the entropy generator generates entropy when it is powered by the power source.

12. The method of claim 11, wherein the entropy provider comprises a controller that controls the generation of entropy by the entropy generator and/or controls the provision of power from the power source to the entropy generator.

13. The method of claim 12, wherein the controller comprises at least one actuator that upon actuation causes the power source to start providing power to the entropy generator, causes the entropy generator to generate entropy, and/or causes the entropy provider to provide entropy generated by the entropy generator to the external computing device.

14. The method of claim 10, wherein the entropy supply comprises a storage that stores entropy, wherein the entropy provider comprises a receiver that receives entropy from an external entropy source when the entropy provider is connected to the external entropy source via the receiver, and wherein the entropy provider stores entropy received from the external entropy source in the storage.

15. The method of claim 14, wherein the storage stores the entropy without requiring energy from the power source.

16. The method of claim 14, wherein the entropy provider comprises a controller that controls the receiving of entropy from the external entropy source and/or controls the provision of entropy from the storage to the external computing device via the transmitter.

17. The method of claim 16, wherein the controller comprises at least one actuator that upon actuation causes the entropy provider to start receiving entropy from the external entropy source, start providing entropy from the storage to the external computing device, and/or provide the same entropy to more than one external computing device.

18. The method of claim 10, wherein the entropy comprises random numbers and/or a random sequence of bits.
